(19) United States
(12) Patent Application Publication
(10) Pub. No.: US 2022/0174940 A1
(43) Pub. Date: Jun. 9, 2022

(54) Quik-Pik Decoy

(71) Applicants: David Hickman, III, Plano, TX (US); Stephen Hickman, Plano, TX (US)

(72) Inventors: David Hickman, III, Plano, TX (US); Stephen Hickman, Plano, TX (US)

(21) Appl. No.: 17/111,216

(22) Filed: Dec. 3, 2020

(51) Int. Cl. A01M 31/06

(52) U.S. Cl. CPC A01M 31/06

(57) ABSTRACT

An article of manufacture for providing a quick and dry decoy retrieval device includes a decoy body shaped as a waterfowl, an anchor line having an upper end and a lower end, an anchor weight coupled to the lower end of the anchor line, the anchor weight and the lower end are below the underside surface, and a finger retrieval loop coupled to the upper end. The decoy body having an upper surface, a head, an underside surface, and a waterfowl decoy keel, and a concealment cavity located in the top surface behind the head, an anchor line channel running from an entry point within the concealment cavity to an exit point on the underside surface about the waterfowl decoy keel. The anchor line being routed through the anchor line channel. The finger retrieval loop being concealed within the concealment cavity when the upper end e is about the entry.

### TECHNICAL FIELD

This application relates in general to an article of manufacture for providing a waterfowl hunting aid device, and more specifically, to an article of manufacture molded within the waterfowl decoy cavity for providing a quick and dry decoy retrieval device.

### BACKGROUND

Duck hunters routinely place decoys of waterfowl ducks resting on the surface of a body of water near where they position themselves in an attempt to attract ducks to approach this body of water. These floating decoys are made to appear to be ducks similar to the ones being hunted. Each decoy has an anchor line having a weighted anchor device tied to the end of the anchor line that is dropped into the water to hold the decoys in position against any wind, current, or tide.

At the end of a day of hunting, the hunter retrieves these waterfowl decoys from the water in order to use them at a later date. The anchor lines have typically been attached to the decoy along a location on a bottom surface of the decoy which is known as a keel that is below the waterline when the waterfowl decoy is floating. When the decoy is retrieved, the hunter follows a three-step process which is to grab the head of the decoy with one hand and pull the waterfowl decoy out of the water, then with the other hand grab a finger retrieval loop in the anchor line which is attached to the underside keel of the decoy and drop the decoy down the anchor line as the loop and anchor line are lifted out of the water. Because duck hunting usually occurs in cold weather, the hunter's hands and/or gloves normally become wet reaching for the anchor line for retrieval. The repeated dunking of the hands into the normally chilly water may cause the hunter's hands to become cracked, chapped, and stained over the course of a hunting season.

Therefore, a need exists for an article of manufacture molded within the waterfowl decoy cavity for providing a quick and dry waterfowl decoy retrieval device and mechanism that simplifies the retrieval process and eliminates the act of getting one's hands wet during the retrieval process. This problem has long existed for hunters that use waterfowl decoys while hunting. Yet, none of the many manufacturers of waterfowl decoys have altered the location of the finger retrieval loop that is part of the anchor line positioned at the underside keel of the decoy in spite of this long-felt need. The present invention attempts to address the limitations and deficiencies of existing waterfowl decoy designs according to principles and example embodiments as disclosed herein.

### SUMMARY

In accordance with the present invention, the above and other problems are solved by providing an article of manufacture molded within the waterfowl decoy cavity for a quick and dry decoy retrieval device according to the principles and example embodiments disclosed herein.

In one embodiment, the present invention is an article of manufacture for providing quick and dry decoy retrieval. The decoy has a decoy body shaped as a waterfowl, a concealment cavity located in a top surface behind a head, an anchor line channel running from an entry point within the concealment cavity to an exit point on the underside surface about a front end of the waterfowl decoy keel, an anchor line having an upper end and a lower end, an anchor weight coupled to the lower end of the anchor line, the anchor weight and the lower end of the anchor line are below the underside surface, and a finger retrieval loop coupled to the upper end of the anchor line. The decoy body having an upper surface, a head coupled to the upper surface, an underside surface, and a waterfowl decoy keel coupled to the underside surface. The anchor line being routed through the anchor line channel. The finger retrieval loop being concealed within the concealment cavity when the upper end of the anchor line is about the entry point to the anchor line channel.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a view of an article of manufacture molded within the waterfowl decoy cavity for providing a quick and dry decoy retrieval device according to the present invention

FIG. 2 illustrates a top view of an article of manufacture molded within the waterfowl decoy cavity for providing a quick and dry decoy retrieval device according to the present invention.

FIG. 3 illustrates a side view of an article of manufacture molded within the waterfowl decoy cavity for providing a quick and dry decoy retrieval device according to the present invention.

FIG. 4 illustrates a front view of an article of manufacture molded within the waterfowl decoy cavity for providing a quick and dry decoy retrieval device according to the present invention.

FIG. 5 illustrates a profile view of an article of manufacture molded within the waterfowl decoy cavity for providing a quick and dry decoy retrieval device according to the present invention.

FIG. 6 illustrates a hanging view of an article of manufacture molded within the waterfowl decoy cavity for providing a quick and dry decoy retrieval device according to the present invention.

### DETAILED DESCRIPTION

This application relates in general to an article of manufacture for providing a waterfowl hunting aid, and more specifically, to an article of manufacture molded within the waterfowl decoy cavity for providing a quick and dry decoy retrieval device according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “customer,” and “user” refer to an entity, e.g. a human, using the quick and dry waterfowl decoy retrieval device associated with the invention. The term user herein refers to one or more users.

The term “invention” or “present invention” refers to the invention being applied for via the patent application with the title “Quik-Pik Decoy Retrieval.” Invention may be used interchangeably with waterfowl decoy.

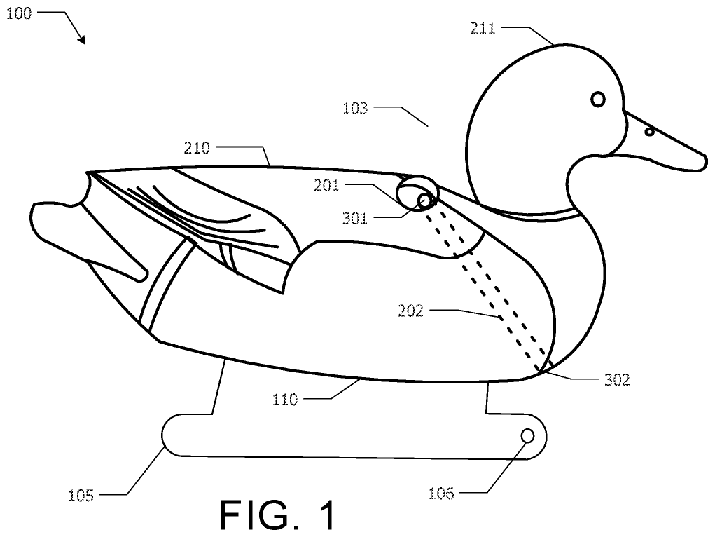

In general, the present disclosure relates to an article of manufacture for providing a waterfowl hunting aid. To better understand the present invention, FIG. 1 illustrates an example embodiment of an article of manufacture molded within the waterfowl decoy cavity for providing a quick and dry decoy retrieval device according to the present invention. A profile view of a waterfowl decoy 100 is shown in FIG. 1. An anchor line channel 202 is shown running from the underside 110 of the decoy body 101 to an anchor weight 104 at its opposite end. The orientation of the anchor line channel 202 is that it runs from bottom of the concealment cavity 201 on an upper surface 210 of the decoy body 101 and behind the decoy head 211 to an exit point 302 at the bottom surface 110 and at the front end of the waterfowl decoy above the front end of the keel 105. An entry point 301 for the anchor line 102 and the anchor line channel 202 may be seen within the concealment cavity 201.

When the decoy 100 is retrieved, the hunter may reach within the concealment cavity to grab an industry standard finger retrieval loop (not shown) which is part of the anchor line (also not shown) and lift the retrieval loop upward, pulling the anchor line through the decoy body 101. The anchor line lifts the anchor weight 104, allowing the waterfowl decoy 100 to be easily removed and stowed for later use.

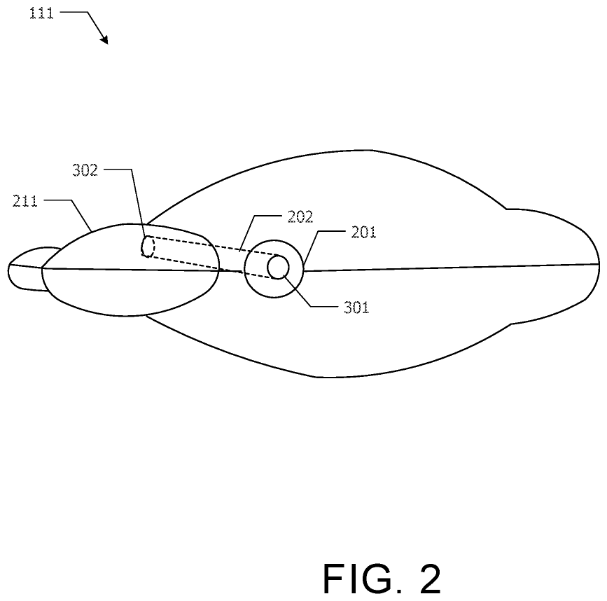

FIG. 2 illustrates a top view of an article of manufacture molded within the waterfowl decoy cavity for providing a quick and dry decoy retrieval device according to the present invention. The concealment cavity 201 is shown centered upon the decoy 111 slightly behind the decoy head 211. The concealment cavity 201 is approximately 1½″ wide and 2″ deep.

The entry point 301 of the anchor line channel 202 is shown within the concealment cavity. The entry point of the anchor line channel 301 has an approximate inside diameter of ¾″. This position allows the anchor line (not shown) to terminate within the concealment cavity. A finger retrieval loop 103 may be configured at the upper end of the anchor line when the decoy 111 is deployed. The finger retrieval loop 103 may be stowed out of sight within the concealment cavity 201 while the decoy 111 is deployed.

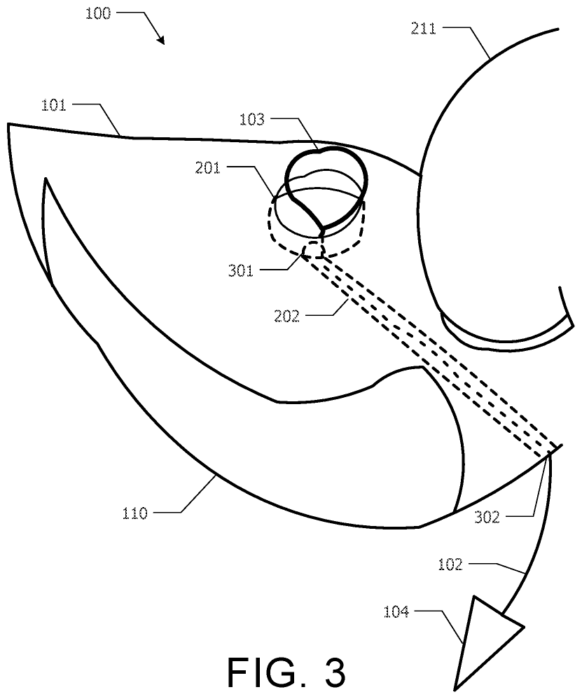

FIG. 3 illustrates another view of an article of manufacture f molded within the waterfowl decoy cavity or providing a quick and dry decoy retrieval device according to the present invention. The decoy's 100 finger retrieval loop 103 is shown exiting the concealment cavity 201. In this embodiment, the concealment cavity 201 is a cylindrical cavity cut into the decoy body 101 along a top surface 210 behind the decoy head 211. The concealment cavity 201 is made large enough and deep enough into the decoy body 101 to permit the entire finger retrieval loop 103 to be stowed within the concealment cavity 201. In a preferred embodiment, the concealment cavity 201 is sized approximately 1.5″ wide and is 2″ deep. The inner surfaces of the concealment cavity 201 are also painted to match the color and texture of the nearby parts of the decoy body 101. The anchor line 102 and the finger retrieval loop 103 are made from a many different sizes and types of cord to meet the preferences and needs of the hunter. The retrieval loop 103 also may be colored to blend into the colors of the concealment cavity 201 to assist in making it less noticeable to nearby waterfowl.

An anchor line channel 202 runs from a bottom surface of the concealment cavity 201 through the decoy body 101 before exiting along the underside 110 of the decoy body 101. The retrieval loop 103 is tied in an upper end of the anchor line 102. The retrieval loop 103 may be stored within a concealment cavity 201 in which the anchor line 102 may pass through the decoy 101 to enter the water. The decoy body 101 is positioned with the retrieval loop 103 near the decoy body 101 with the anchor weight 104 deployed in the water while secured by the anchor line 102. The decoy 100 may move along the anchor line 102 such that the anchor line is fully deployed when the retrieval loop 103 is closest to the decoy body 101. When deployed, the finger retrieval loop 103 is stored within the concealment cavity to be out of sight to ducks as they approach the water and the decoys.

The finger retrieval loop 103 will be pulled deep into the concealment cavity 201 as the decoy 100 anchor line 102 and anchor weight 104 is deployed. Water that holds the decoy 100 stationary against a taut anchor line 102 that is held in place by the anchor weight 104 provides a retaining force that keeps the retrieval loop 103 within the concealment cavity 201. A hunter may simply reach into the concealment cavity 201 to grab the retrieval loop 103 when the decoy 100 is to be retrieved.

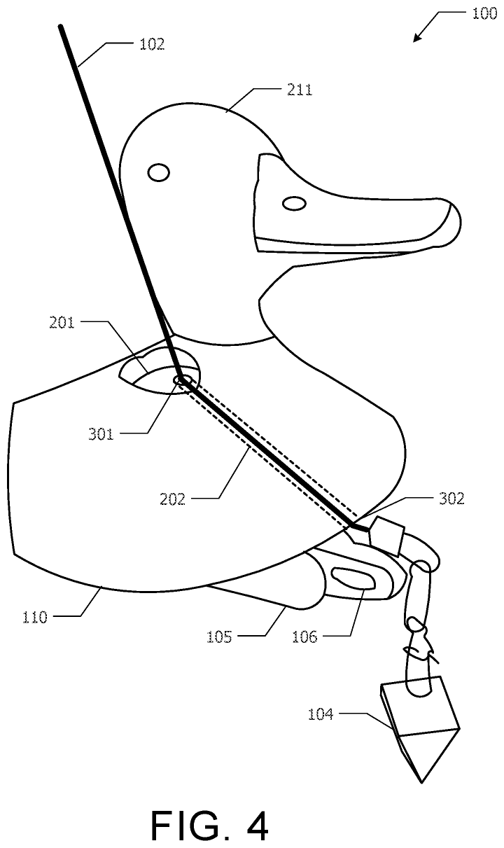

FIG. 4 illustrates a front view of an article of manufacture molded within the waterfowl decoy cavity for a quick and dry decoy retrieval device according to the present invention. The anchor line 102 is shown exiting the concealment cavity 201. The orientation of the anchor line channel 202 is that it runs from the entry point 301 within the concealment cavity 201 on the upper surface 210 of the decoy body 101 and behind the decoy head 211 to an exit point 302 at the front of the waterfowl decoy 100 along the bottom surface 110 of the decoy body 101.

A waterfowl decoy keel 105 having a keel anchor line eyelet opening 106 is shown extending out from the underside of the decoy body 110. The exit point 302 of the anchor line channel 202 is placed adjacent to the keel anchor line eyelet of the waterfowl decoy keel 105. As such, the anchor line 102 may exit the anchor line channel 202 to engage the keel anchor line eyelet 106 before falling away from the decoy 100 to the anchor weight 104.

The anchor line 102 may be made of varying lengths to ensure that the anchor weight 104 reaches the bottom of the body of water when deployed. The anchor weight 104 may have varying shapes and features as needed to maintain its position along the bottom of the body of water under the weather and water conditions encountered while hunting.

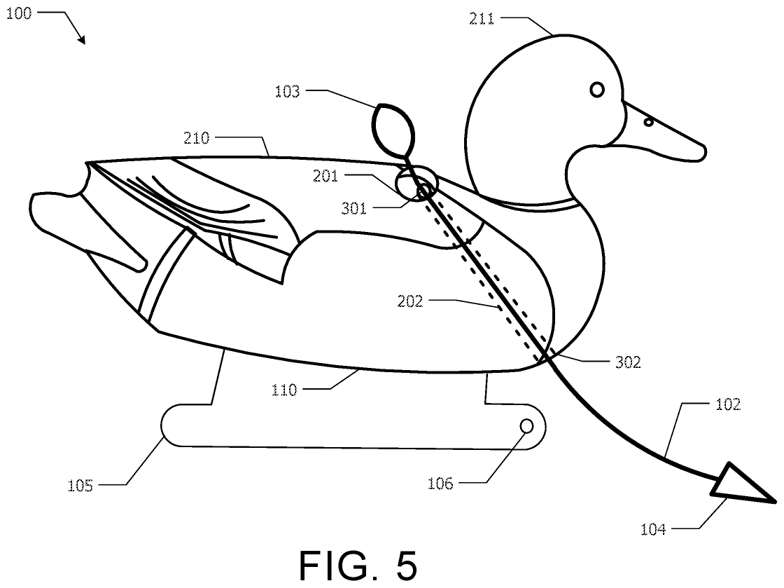

FIG. 5 illustrates a profile view of an article of manufacture molded within the waterfowl decoy cavity for providing a quick and dry decoy retrieval device according to the present invention. The anchor line 102 is shown starting at the finger retrieval loop 103, running through the anchor line channel 202 from the entry point 301 within the concealment cavity 201 to the exit point 302 on the underside of the decoy 110 and ending at the anchor weight 104. The entire waterfowl decoy keel is shown molded to the underside of the decoy 110.

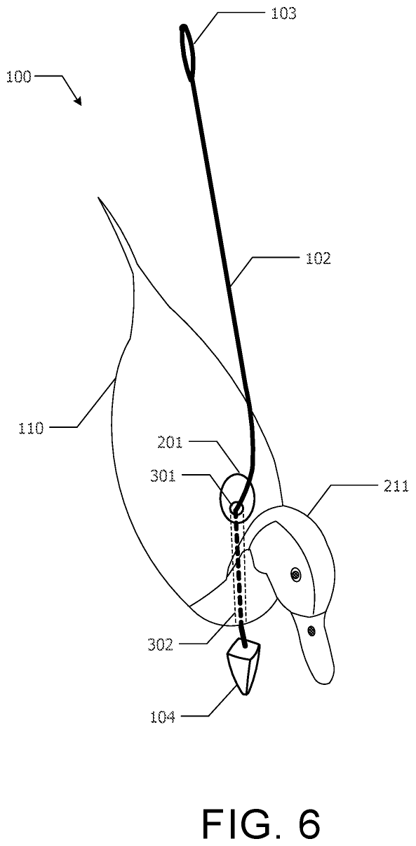

FIG. 6 illustrates a hanging view of an article of manufacture molded within the waterfowl decoy cavity for providing a quick and dry decoy retrieval device according to the present invention. The decoy 100 is shown suspended along the anchor line 102 as the finger retrieval loop 103 is held in the air. As the finger retrieval loop 103 is pulled upward from the decoy 100, the anchor line 102 passes through the anchor line channel 102 and the anchor weight 104 is raised. The anchor line 102 will be held in place when the anchor weight 104 rises to abut the exit point 302 of the anchor line channel 202. The hunter may lift the decoy from the water once the anchor weight 104 has been lifted to the underside of the decoy 110.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture molded within the waterfowl decoy cavity for providing a quick and dry decoy retrieval device, the article comprises:
a decoy body shaped as a waterfowl, the decoy body having an upper surface, a head coupled to the upper surface, an underside surface, and a waterfowl decoy keel coupled to the underside surface;
a concealment cavity located in a top surface behind the head;
an anchor line channel running from an entry point within the concealment cavity to an exit point on the underside surface to the front end of the waterfowl decoy keel;
an anchor line having an upper end and a lower end, the anchor line being routed through the anchor line channel;
an anchor weight coupled to the lower end of the anchor line, the anchor weight and the lower end of the anchor line are below the underside surface; and
a finger retrieval loop coupled to the upper end of the anchor line, the finger retrieval loop being concealed within the concealment cavity when the upper end of the anchor line is about the entry point to the anchor line channel.

2. The article of manufacture according to claim 1, wherein anchor weight and the anchor line are fully deployed when the finger retrieval loop is within the concealment cavity;

3. The article of manufacture according to claim 1, wherein anchor weight and the lower end of the anchor line are about the exit point of the anchor line channel when the finger retrieval loop is fully pulled out of the concealment cavity.

4. The article of manufacture according to claim 1, wherein the decoy body and the head are configured to appear as a waterfowl resting on top of a body of water.

5. The article of manufacture according to claim 1, wherein the finger retrieval loop is made from an end portion of the upper end of the anchor line being tied to itself.

6. The article of manufacture according to claim 1, wherein the finger retrieval loop comprises a flexible ring coupled to the upper end of the anchor line, the flexible ring is sized to fit completely within the concealment cavity.
